(19) United States
(12) Patent Application Publication
(10) Pub. No.: US 2025/0132392 A1
(43) Pub. Date: Apr. 24, 2025

(54) LITHIUM-ION SECONDARY BATTERY

(71) Applicant: TOYOTA JIDOSHA KABUSHIKI KAISHA, Toyota-shi Aichi-ken (JP)

(72) Inventor: Kyosuke Yoshida, Susono-shi Shizuoka-ken (JP)

(73) Assignee: TOYOTA JIDOSHA KABUSHIKI KAISHA, Toyota-shi Aichi-ken (JP)

(21) Appl. No.: 18/892,713

(22) Filed: Sep. 23, 2024

(30) Foreign Application Priority Data
Oct. 23, 2023 (JP) 2023-181807

(51) Int. Cl. H01M 10/0569; H01M 4/02; H01M 4/38; H01M 10/0525

(52) U.S. Cl. CPC H01M 10/0569; H01M 4/386; H01M 10/0525; H01M 2004/027; H01M 2300/0034

(57) ABSTRACT

A lithium-ion secondary battery having improved coulombic efficiency. A lithium ion secondary battery comprises, a negative electrode active material layer, a separator layer, and a positive electrode active material layer in the order mentioned, wherein the negative electrode active material layer comprises a silicon-based negative electrode active material, and wherein the negative electrode active material layer, the separator layer, and the positive electrode active material layer are impregnated with an electrolyte solution, wherein the electrolyte solution comprises an ionic liquid and a lithium ion, wherein the ionic liquid comprises a phosphonium ion and a bis(fluorosulfonyl)imide ion.

### CROSS-REFERENCE TO RELATED APPLICATIONS

This application claims priority to Japanese Patent Application No. 2023-181807 filed Oct. 23, 2023, the entire contents of which are herein incorporated by reference.

### FIELD

The present disclosure relates to a lithium-ion secondary battery.

### BACKGROUND

In lithium-ion secondary batteries, it is known that a solid-electrolyte interface (SEI) is formed at an interface between an electrode-active material and an electrolyte solution. These SEI are often a combination of an electrode active material and an electrolytic solution, and optionally include a decomposition product of an electrolytic solution. SEI functions as a protective layer that protects the electrode active material and the electrolyte solution from corroding and other undesirable side reactions on the electrode active material surface. As a battery having a stable SEI using an ionic liquid as an electrolytic solution, a battery as described below is disclosed.

For example, PLT 1 discloses that a process for manufacturing a lithium-ion battery having a protected anode with a preformed solid electrolyte interface (SEI) comprising: SEI forming electrolyte, performing a plurality of charge-discharge cycles on a lithium electrode in a first cell having a lithium-forming electrolyte to form a SEI on said lithium electrode to form a protected anode, wherein said SEI forming electrolyte comprises lithium bis(fluorosulfonyl)imide (LiFSI) and an ionic liquid, wherein said ionic liquid comprises 1-methyl-1-propylpyrrolidinium, N-methyl-N,N-diethyl-N-propylammonium, N,N-diethyl methylmethoxyethyl-ammonium, 1,1-methylpropylpiperidinium, methylmethyl-N-(2-methoxyethyl)-pyrrolidinium, trimethyl isopropylphosphonium, methyltriethylphosphonium, methyl tributylphosphonium, Disclosed is a method of making a lithium-ion battery comprising organic cations selected from the group consisting of: and mixtures thereof; and a (fluorosulfonyl)imide anion (FSI), the method further comprising assembling a wet Li ion voltaic cell, the wet Li ion voltaic cell comprising: the protected anode; and a wet electrolyte contacting the protected anode, the wet electrolyte comprising at least an 50 ppm of water. According to a method of manufacturing a lithium-ion battery of PLT 1, it teaches that an improved method for protecting a lithium anode against moisture in an electrolyte can be provided.

PLT 2 discloses an electrolyte including an active material containing nanosilicon, a polyacrylonitrile polymer that connects the active material and conducts electricity and lithium ions, and an electrolyte that contacts the active material, the active material including a LiFSI salt and an ionic liquid having an anion of bis(fluorosulfonyl)imide (FSI).

PLT 3 discloses a system for generating electrical energy from chemicals in a compartmentalized cell comprising at least two electrodes having at least one anode and at least one intercalation cathode, at least one separator separating said anode and said cathode, an ionic liquid electrolyte system having an ionic liquid solvent mixed with a minority-side fraction of an ether co-solvent, and a lithium salt solute.

### CITATION LIST

### Patent Literature

[PTL 1] Japanese Unexamined Patent Publication (Kokai) No. 2018-200873
[PTL 2] Japanese Unexamined Patent Application Publication (Translation of PCT Application) No. 2017-539051
[PLT 3] Japanese Unexamined Patent Application Publication (Translation of PCT Application) No. 2022-516205

### SUMMARY

### Technical Problem

As described above, SEI functions as a protective layer that protects the electrode active material and the electrolyte solution from corroding and other undesirable side reactions on the electrode active material surface. On the other hand, when a silicon-based negative electrode active material is used as an electrode active material in a liquid-based battery, the expansion and contraction of the silicon-based negative electrode active material may cause SEI to crack and form a new surface of SEI, thereby continuing to decompose the electrolyte and grow SEI. Therefore, electric energy is utilized in addition to charge and discharge, and thereby coulomb efficiency may be lowered.

It is therefore an object of the present disclosure to provide a lithium-ion secondary battery having improved coulombic efficiency.

### Solution to Problem

The present disclosure achieves the above-described object by the following techniques.

### <Aspect 1>

A lithium-ion secondary battery comprises, a negative electrode active material layer, a separator layer, and a positive electrode active material layer in the order mentioned, wherein the negative electrode active material layer comprises a silicon-based negative electrode active material, and wherein the negative electrode active material layer, the separator layer, and the positive electrode active material layer are impregnated with an electrolyte solution, wherein the electrolyte solution comprises an ionic liquid and a lithium ion, wherein the ionic liquid comprises a phosphonium ion and a bis(fluorosulfonyl)imide ion.

### <Aspect 2>

The lithium-ion secondary battery according to aspect 1, wherein the phosphonium ion is a triethylpropylphosphonium ion.

### <Aspect 3>

The lithium-ion secondary battery according to aspect 1 or 2, wherein the specific surface area of the silicon-based negative electrode active material is 25 m²/g or less.

### <Aspect 4>

The lithium-ion secondary battery according to any one of aspects 1 to 3, wherein the molar ratio of the total amount of moles of the phosphonium ion and the bis(fluorosulfonyl)imide ion to the total amount of moles of the lithium ion and the bis(fluorosulfonyl)imide ion is 1.5 or less.

### Effects

According to the lithium-ion secondary battery of the present disclosure, coulombic efficiency can be improved.

### BRIEF DESCRIPTION OF DRAWINGS

FIG. 1 is a graph comparing the average coulombic efficiencies of the lithium-ion secondary batteries in examples 1 and 2 and comparative examples 1 to 3.

FIG. 2 is a graph comparing the average Coulombic efficiency of the lithium-ion secondary batteries of examples 2-3.

### DESCRIPTION OF EMBODIMENTS

Embodiments of the present disclosure will now be described in detail. The present disclosure is, however, not limited to the below-described embodiments, and can be carried out with various modifications within the scope of the gist of the present disclosure. In the descriptions of the drawings, the same symbol is assigned to the same element, and redundant descriptions are omitted.

Regarding the present disclosure, the term “mixture” means a composition which, by itself or by further containing other components, can constitute a positive electrode active material layer or an electrolyte layer. Further, regarding the present disclosure, the term “mixture slurry” means a slurry which contains a dispersion medium in addition to a “mixture”, and can thus be applied and dried to form a positive electrode active material layer or an electrolyte layer.

The lithium ion secondary battery of the present disclosure may be a liquid-based battery in which a negative electrode active material layer, a separator layer, and a positive electrode active material layer are impregnated with an electrolytic solution, and may be a solid battery having a solid electrolyte layer as a separator layer. It should be noted that, for purposes of the present disclosure, “solid state battery” means a battery that uses at least a solid electrolyte as the electrolyte, and thus, for purposes of the present disclosure, a solid state battery uses a combination of a solid electrolyte and an electrolyte as the electrolyte.

### <<Lithium-ion Secondary Battery>>

The lithium-ion secondary battery of the present disclosure comprises a negative electrode active material layer, a separator layer, and a positive electrode active material layer in the order mentioned,
wherein the negative electrode active material layer comprises a silicon-based negative electrode active material, and
wherein the negative electrode active material layer, the separator layer, and the positive electrode active material layer are impregnated with an electrolyte solution,
   wherein the electrolyte solution comprises an ionic liquid and a lithium ion,
   wherein the ionic liquid comprises a phosphonium ion and a bis(fluorosulfonyl)imide ion.

According to the lithium-ion secondary battery of the present disclosure, coulombic efficiency can be improved.

The lithium-ion secondary battery of the present disclosure includes a silicon-based negative electrode active material in a negative electrode active material layer, and comprises phosphonium ions in an electrolytic solution. It is known that a silicon-based negative electrode active material has a larger expansion and contraction than other negative electrode materials, and a SEI formed in a silicon-based negative electrode active material is cracked with charge and discharge, and a new surface of a SEI is formed, whereby decomposition of an electrolyte solution and growth of a SEI continue to occur.

Although not clear, it is presumed that the inclusion of phosphonium ions in the electrolyte resulted in the formation of a SEI which is effective for the expansion and contraction of the silicon-based negative electrode active material, that is, a SEI cracked when the silicon-based negative electrode active material is used, and a new surface of SEI is formed, thereby suppressing the problem that SEI continues to grow, thereby improving the Coulombic Efficiency. It is also speculated that the phosphonium ion suppresses the overformation of SEI due to its high electrochemical stabilities, thereby improving the Coulombic efficiency.

### <Configuration of Lithium-Ion Rechargeable Battery>

In the lithium-ion secondary battery of the present disclosure, the lithium ion secondary battery comprises a negative electrode active material layer, a separator layer, and a positive electrode active material layer in this order mentioned.

The lithium ion secondary battery of the present disclosure may further include a negative electrode current collector layer and a positive electrode current collector layer, and may have a negative electrode current collector layer, a negative electrode active material layer, a separator layer, a positive electrode active material layer, and a positive electrode current collector layer in this order.

### <Negative Electrode Current Collector Layer>

The material used for the negative electrode current collector layer is not particularly limited, but a material generally used for a negative electrode current collector of a lithium-ion secondary battery can be appropriately adopted. The negative electrode current collector layer may be made of Cu, Ni, Cr, Au, Pt, Ag, Al, Fe, Ti, Zn, Co, stainless-steel, or carbon sheet. The negative electrode current collector layer is not limited to these cases. In particular, from the viewpoints of securing reduced resistance and difficulty in alloying with lithium, the negative electrode current collector layers may contain at least one metal selected from Cu, Ni, and stainless-steel, or may be made of carbon sheet. The negative electrode current collector layer may have some kind of coating layer on its surface for the purpose of adjusting resistor or the like.

The shape of the negative electrode current collector layer is not particularly limited, and may be, for example, a foil, a plate, a mesh, or the like.

The thickness of the negative electrode current collector layer is not particularly limited, but may be 0.1 μm or more, or 1 μm or more, and may be 1 mm or less, or 100 μm or less.

### <Negative Electrode Active Material Layer>

The negative electrode active material layer includes at least a silicon-based negative electrode active material, and may further optionally include a conductive auxiliary agent, a binder, a solid electrolyte, and the like. The negative electrode active material layer may contain various other additives. The content of each of the negative electrode active material, the conductive auxiliary agent, the binder, and the like in the negative electrode active material layer may be appropriately determined according to the purpose battery performance. For example, the content of the negative electrode active material may be 40% by mass or more, 50% by mass or more, or 60% by mass or more, and may be 100% by mass or less, or 90% by mass or less, taking the entire negative electrode active material layer (total solid content) as 100% by mass.

### (Negative Electrode Active Material)

The negative electrode active material layer may contain a negative electrode active material other than the silicon-based negative electrode active material.

Examples of the silicon-based negative electrode active material include, but are not limited to, silicon, silicon oxide, silicon carbide, silicon nitride, and a solid solution thereof. The silicon-based negative electrode active material may include a metallic element other than silicon, for example, Fe, Co, Sb, Bi, Pb, Ni, Cu, Zn, Ge, In, Sn, Ti or the like.

Although there is no particular limitation on the shape of the silicon-based negative electrode active material, any shape may be used as the silicon-based negative electrode active material of the lithium-ion secondary battery. The shape of the silicon-based negative electrode active material may be particulate. The silicon-based negative electrode active material may be a primary particle or a secondary particle in which a plurality of primary particles is aggregated. The specific surface area of the silicon-based negative electrode active material is not particularly limited, but may be 25 m²/g or less. The surface area of the silicon-based negative electrode active material may be, for example, 0.1 m²/g or more, 0.2 m²/g or more, 0.4 m²/g or more, 0.6 m²/g or more, 0.8 m²/g or more, or 1 m²/g or more, and may be 50 m²/g or less, 40 m²/g or less, 30 m²/g or less. Note that the specific surface area can be determined by BET method using nitrogen as an adsorbate.

The negative electrode active material other than the silicon-based negative electrode active material is not particularly limited, but may be a material capable of occluding and releasing a metal ion such as lithium ion, and may be a metal lithium. Examples of the material capable of occluding and releasing metal ions such as lithium ions include, but are not limited to, a Sn alloy-based negative electrode active material and a carbon material. Examples of Sn alloy-based negative electrode active material include tin, tin oxide, tin nitride, and a solid solution thereof. Further, Sn alloy-based negative electrode active material may include a metallic element other than tin, for example, Fe, Co, Sb, Bi, Pb, Ni, Cu, Zn, Ge, In, Ti, Si, or the like. The carbon material is not particularly limited, and examples thereof include hard carbon, soft carbon, and graphite.

The shape of the negative electrode active material other than the silicon-based negative electrode active material is not particularly limited, but may be any shape as long as it is a general shape as a negative electrode active material of a lithium-ion secondary battery. The shape of the negative electrode active material other than the silicon-based negative electrode active material may be particulate. The negative electrode active material other than the silicon-based negative electrode active material may be a primary particle or a secondary particle in which a plurality of primary particles is aggregated.

The proportion of the silicon-based negative electrode active material contained in the negative electrode active material layer is not particularly limited, but may be 50% by mass to 100% by mass, 60% by mass to 100% by mass, 70% by mass to 100% by mass, 80% by mass to 100% by mass, or 90% by mass to 100% by mass with respect to the negative electrode active material layer.

### (Conductive Auxiliary Aid)

The conductive auxiliary agent is not particularly limited. The conductive aid may be, for example, but not limited to, vapor grown carbon fiber (VGCF), acetylene black (AB), ketjen black (KB), carbon nanotube (CNT), carbon nanofiber (CNF), and the like. The conductive auxiliary agent may be, for example, particulate or fibrous, and the size thereof is not particularly limited. The conductive auxiliary agent is not particularly limited, but only 1 kinds thereof may be used alone, and 2 or more kinds thereof may be used in combination.

### (Binder)

The binder is not particularly limited. The binder may be, for example, a material such as, but not limited to, polyvinylidene fluoride (PVdF), butadiene rubber (BR), polytetrafluoroethylene (PTFE), styrene butadiene rubber (SBR), and polyacrylic acid (PAA). The binder is not particularly limited, but only 1 kinds thereof may be used alone, and 2 or more kinds thereof may be used in combination.

### (Solid Electrolyte)

The material of the solid electrolyte is not particularly limited, and may be, for example, a sulfide solid electrolyte, an oxide solid electrolyte, or a polymer electrolyte.

Examples of the sulfide solid electrolyte include, but are not limited to, a sulfide-based amorphous solid electrolyte, a sulfide-based crystalline solid electrolyte, or an argyrodite-type solid electrolyte. Examples of the sulfide solid electrolyte include, but are not limited to, sulfide-based amorphous solid electrolytes, sulfide-based crystalline solid electrolytes, and argyrodite-type solid electrolytes. Specific examples of the sulfide solid electrolyte include, but are not limited to: Li₂S—P₂S₅-based electrolytes (e.g., Li₇P₃S₁₁, Li₃PS₄, and Li₃P₂S₉), Li₂S—SiS₂, LiI—Li₂S—SiS₂, LiI—Li₂S—P₂S₅, LiI—LiBr—Li₂S—P₂S₅, Li₂S—P₂S₅—GeS₂ (e.g., Li₁₃GeP₃S₁₆ and Li₁₀GeP₂S₁₂), LiI—Li₂S—P₂O₅, LiI—Li₃PO₄—P₂S₅, and Li₇₋ₓ PS₆₋ₓ Cl_{X}; and combinations thereof.

Examples of the oxide solid electrolyte include, but are not limited to, Li₇La₃Zr₂O₁₂, Li₇₋ₓ La₃Zr₁₋ₓ Nb_{X}O₁₂, Li₇₋₃ₓLa₃Zr₂Al_{X}O₁₂, Li₃ₓLa_{2/3-x} TiO₃, Li₁₊ₓAl_{X}Ti₂₋ₓ (PO₄)₃, Li₁₊ₓAl_{X}Ge₂₋ₓ (PO₄)₃, Li₃PO₄, and Li₃₊ₓPO₄₋ₓ N_{X} (LiPON).

The sulfide solid electrolyte and the oxide solid electrolyte may each be a glass or a crystallized glass (glass-ceramic).

Examples of the polymer electrolyte include, but are not limited to, polyethylene oxide (PEO), polypropylene oxide (PPO), and copolymers thereof.

The shape of the negative electrode active material layer is not particularly limited, but may be, for example, a sheet-like negative electrode active material layer having a substantially planar surface. The thickness of the negative electrode active material layer is not particularly limited, but may be, for example, 0.1 μm or more, 1 μm or more, or 10 μm or more, and may be 2 mm or less, 1 mm or less, or 500 μm or less.

The negative electrode active material layer can be manufactured by applying a known method. For example, the negative electrode active material layer can be easily formed by molding a negative electrode mixture containing various components described above in a dry or wet manner or the like. The negative electrode active material layer may be molded together with the negative electrode current collector layer, or may be molded separately from the negative electrode current collector layer.

### <Separator Layer>

The separator layer is not particularly limited, and for example, a nonwoven fabric such as a polyolefin type, a polyamide type, or a polyimide type can be used.

### <Positive Electrode Active Material Layer>

The positive electrode active material layer includes at least a positive electrode active material, and may further optionally include a conductive auxiliary agent, a binder, a solid electrolyte, and the like. The positive electrode active material layer may contain various other additives. The content of each of the positive electrode active material, the conductive auxiliary agent, the binder, and the like in the positive electrode active material layer may be appropriately determined according to the purpose battery performance. For example, the entire positive electrode active material layer (total solid content) is set to 100% by mass, and the content of the positive electrode active material may be 40% by mass or more, 50% by mass or more, or 60% by mass or more, and may be 100% by mass or less, or 90% by mass or less.

### (Positive Electrode Active Material)

The material of the positive electrode active material is not particularly limited. Examples of the positive electrode active material include, but are not limited to, lithium cobaltate (LiCoO₂), lithium nickelate (LiNiO₂), lithium manganate (LiMn₂O₄), nickel-cobalt-lithium manganate (NCM), LiCO_{1/3}Ni_{1/3}Mn_{1/3}O₂, nickel-cobalt-lithium aluminate (NCA;LiNiₓCo_{y}Al_{z}O₂), Li₁₊ₓMn_{2-x-y} MyO₄ where M is one or more metallic elements selected from Al, Mg, Co, Fe, Ni, and Zn), and the like.

The positive electrode active material is not particularly limited, but may have a coating layer. The coating layer is a layer containing a substance which has lithium-ion conduction performance, has low reactivity with a positive electrode active material or a solid electrolyte, and can maintain a form of a coating layer which does not flow even when in contact with an active material or a solid electrolyte. Example of the covering layers include, but are not limited to, LiNbO₃ and Li₄Ti₅O₁₂, Li₃PO₄.

The shape of the positive electrode active material is not particularly limited as long as it has a general shape as a positive electrode active material of a lithium-ion secondary battery. The positive electrode active material may be, for example, particulate. The positive electrode active material may be a primary particle or a secondary particle in which a plurality of primary particles is aggregated. The mean grain size D₅₀ of the positive electrode active material may be, for example, not less than 1 nm, not less than 5 nm, or not less than 10 nm, and may be not more than 500 μm, not more than 100 μm, not more than 50 μm, or not more than 30 μm. The mean particle diameter D₅₀ is a particle diameter (median diameter) at an integral of 50% in the volume-based particle size distribution determined by a laser diffraction/scattering method.

For the conductive auxiliary agent, the binder, and the solid electrolyte, reference can be made to the description of <Negative electrode active material layer> described above.

The shape of the positive electrode active material layer is not particularly limited, but may be, for example, a sheet-like positive electrode active material layer having a substantially planar surface. The thickness of the positive electrode active material layer is not particularly limited, but may be, for example, 0.1 μm or more, 1 μm or more, or 10 μm or more, and may be 2 mm or less, 1 mm or less, or 500 μm or less.

### <Positive Electrode Current Collector Layer>

The material used for the positive electrode current collector layer is not particularly limited, but a material generally used for a positive electrode current collector of a lithium-ion secondary battery can be appropriately adopted. The positive electrode current collector layers may be made of, for example, Cu, Ni, Cr, Au, Pt, Ag, Al, Fe, Ti, Zn, Co, stainless-steel, or the like, but the present disclosure is not limited thereto. The positive electrode current collector layer may have a coating layer on its surface for the purpose of adjusting resistor or the like. The positive electrode current collector layer may be formed by plating or vapor-depositing the above metal on a metal foil or a base material.

The shape of the positive electrode current collector layer is not particularly limited, and may be, for example, a foil shape, a plate shape, a mesh shape, or the like. In some embodiments, a foil shape is used.

The thickness of the positive electrode current collector layer is not particularly limited, but may be 0.1 μm or more, or 1 μm or more, and may be 1 mm or less, or 100 μm or less.

The positive electrode active material layer can be manufactured by applying a known method. For example, the positive electrode active material layer can be easily molded by molding the positive electrode mixture containing various components described above in a dry or wet manner. The positive electrode active material layer may be molded together with the positive electrode current collector layer, and may be molded separately from the positive electrode current collector layer.

### <Electrolyte Solution>

In the lithium-ion secondary battery of the present disclosure, a negative electrode active material layer, a separator layer, and a positive electrode active material layer are impregnated with an electrolytic solution.

An electrolytic solution of a lithium-ion secondary battery of the present disclosure contains an ionic liquid and lithium ions. The electrolytic solution may contain a support salt (lithium salt). The lithium ion contained in the electrolytic solution is not particularly limited, but may be one in which the supporting salt is ionized.

### (Ionic Liquid)

The ionic liquid contained in the electrolytic solution of the lithium-ion secondary battery of the present disclosure includes phosphonium ions and bis(fluorosulfonyl)imide ions.

### (Phosphonium Ion)

The phosphonium ion can be represented by the following general formula (1).

[PR₁R₂R₃R₄]⁺ (1)

In formulae (1), R₁-R₄ are the same or different and represent an alkyl group which may be substituted (in some embodiments, an unsubstituted alkyl group) or a hydrogen atom (provided that R₁-R₄ is not a hydrogen atom at the same time). The alkyl group is not particularly limited as long as the phosphonium ion can form an ionic liquid. The alkyl group may be either branched or linear, but, in some embodiments, is linear. Examples of the alkyl group include an alkyl group having 1 to 5 carbon atoms or an alkyl group having 1 to 3 carbon atoms. Alkyl groups are not particularly limited, and specifically include, for example, methyl groups, ethyl groups, propyl groups, butyl groups, and pentyl groups. Among them, from the viewpoint of Coulombic efficiency of the lithium-ion secondary battery, the phosphonium ion is not particularly limited, but, in some embodiments, the phosphonium ion is a tricthylpropylphosphonium ion.

### (Supporting Salt)

The support salt is not particularly limited, and examples thereof include an inorganic lithium salt and an organic lithium salt. Examples of inorganic lithium-halides include, but are not limited to, LiPF₆, LiBF₄, LiCIO₄, LiAsF₆, and the like. Examples of organolithium halides include, but are not limited to, LiCF₃SO₃, LIN (CF₃SO₂)₂, LIN (C₂F₅SO₂)₂, LIN (FSO₂)₂, LiC(CF₃SO₂)₃, and the like. Among them, since an ionic liquid containing a bis(fluorosulfonyl)imide ion is present in the electrolyte, there is no particular limitation in terms of the same anions, but, in some embodiments, LiN(FSO₂)₂ is used.

### (Molar Ratio of Ionic Liquid to Lithium Ion)

With respect to the total number of moles of lithium ions and bis(fluorosulfonyl)imide ions, the molar ratio of the total number of moles of phosphonium ions and bis(fluorosulfonyl)imide ions may be 6.0 or less, 4.0 or less, 2.0 or less, or 1.5 or less, and may be 0.2 or more, 0.4 or more, 0.6 or more, 0.8 or more, or 1.0 or more from the viewpoint of Coulombic efficiency. In some embodiments, the molar ratio of the total number of moles of phosphonium ions and bis (fluorosulfonyl)imide ions to the total number of moles of lithium ions and bis(fluorosulfonyl)imide ions is 1.5 or less from the viewpoint of improving Coulombic efficiency. It is considered that when the above molar ratio becomes small, the coordination state in the electrolytic solution changes, so that the reduction stability is improved, and the coulombic efficiency is improved.

The electrolytic solution is not particularly limited, but may contain a solvent other than an ionic liquid. The solvent is not particularly limited, and examples thereof include cyclic carbonate and chain carbonate. Examples of the cyclic carbonate include, but are not limited to, ethylene carbonate (EC), propylene carbonate (PC), and butylene carbonate (BC). Examples of the chain carbonate include, but are not limited to, dimethyl carbonate (DMC), diethyl carbonate (DEC), ethyl methyl carbonate (EMC), and the like. Further, examples of the solvent include acetates such as methyl acetate and ethyl acetate, and Ether such as 2-methyltetrahydrofuran, but are not limited thereto. Further, solvents include, but are not limited to, γ-butyl lactone, sulfolane, N-methyl pyrrolidone (NMP), 1,3-dimethyl-2-imidazolidinone (DMI), and the like. Also, the solvent may be water.

A method of forming the lithium-ion secondary battery is not particularly limited, and a known method can be employed. As a method of forming a lithium ion secondary battery, for example, a step of disposing a negative electrode active material layer, a separator layer, and a positive electrode active material layer in this order, injecting an electrolytic solution, and impregnating the negative electrode active material layer, the separator layer, and the positive electrode active material layer with an electrolytic solution may be included, but is not limited thereto.

### EXAMPLES

The present disclosure will now be described in more detail referring to the below-described Examples; however, the scope of the present disclosure is not limited to the below-described Examples. Note that, although the half-cell used in the embodiment of the present disclosure is configured to be mainly composed of a silicon-based negative electrode active material layer and an ionic liquid, and a simple evaluation using metallic lithium as a counter electrode is performed, this is for clearly comparing the coulombic efficiency of the half cell.

### Example 1

### Preparation of Negative Electrode Active Material LayerA1

A negative electrode mixture slurry was prepared by mixing silicon having a 1 m²/g specific surface area as a silicon-based negative electrode active material, a polyimide-based binder as a binder, a vapor deposition method carbon fiber (VGCF) as a conductive auxiliary agent, and carbon (KB) having a hollow-structure, and an appropriate amount of solvents. The obtained negative electrode mixture slurry was applied to a Cu foil as a negative electrode current collector, dried, and a negative electrode active material layer A1 was manufactured on the negative electrode current collector.

### Preparation of Electrolyte Solution B1

To triethylpropylphosphonium bis(fluorosulfonyl)imide (hereinafter referred to as “P2223-FSI”) as an ionic liquid, lithium bis(fluorosulfonyl)imide (hereinafter referred to as “Li—FSI”) as a support salt containing lithium ions was dissolved so that the molar ratio (P2223-FSI/Li—FSI) of P2223-FSI to Li—FSI was 6 to preparate the electrolyte solution B1.

### Production of Lithium-Ion Secondary Battery C1

The negative electrode active material layer A1 and the lithium foil as a counter electrode were opposed to each other via a separator and contained in a container. Then, an electrolyte B1 was injected into this container, and the container was sealed to prepare a lithium-ion secondary battery C1.

### <Electrochemical Evaluation of Lithium-Ion Secondary Battery C1>

A lithium-ion secondary battery C1 was charged and discharged for 100 cycles at a constant current-constant voltage condition (current value: 0.1 C) with a specified charge capacity in 1200 mAh/g. Coulomb efficiency in each cycle was measured, then the average coulomb efficiency from cycle 4 to cycle 100 was calculated, and the average coulomb efficiency up to the 100 the cycle was determined. The average coulombic efficiency of the lithium-ion secondary battery C1 up to the 100th cycle was 99.0%. Since the coulombic efficiency decreases from the first cycle to the third cycle due to the initial SEI formation, the average coulombic efficiency was calculated from the fourth cycle.

### Example 2

### Preparation of Electrolyte Solution B1

In P2223-FSI as an ionic liquid, Li—FSI as a support salt containing lithium ions was dissolved so that the molar ratio of P2223-FSI to Li—FSI(P2223-FSI/Li—FSI) was 1.5 to preparate the electrolyte solution B2.

### Preparation of Lithium-ion Secondary Battery C2 and Electrochemical Evaluation

The negative electrode active material layer A1 and the lithium foil as a counter electrode were opposed to each other via a separator and contained in a container. Then, an electrolyte B2 was injected into this container, and the container was sealed to prepare a lithium-ion secondary battery C2. The lithium-ion secondary battery C2 was evaluated electrochemically in the same manner as the lithium-ion secondary battery C1. The average coulombic efficiency of the lithium-ion secondary cell C2 up to the 100th cycle was 99.5%.

### Example 3

### Preparation of Negative Electrode Active Material Layer A2

A negative electrode mixture slurry was prepared by mixing silicon having a 25 m²/g specific surface area as a silicon-based negative electrode active material, a polyimide-based binder as a binder, a vapor deposition method carbon fiber (VGCF) as a conductive auxiliary agent, and carbon (KB) having a hollow-structure, and an appropriate amount of solvents. The obtained negative electrode mixture slurry was applied to a Cu foil as a negative electrode current collector, dried, and a negative electrode active material layer A2 was manufactured on the negative electrode current collector.

### Preparation of Lithium-Ion Secondary Battery C3 and Electrochemical Evaluation

The negative electrode active material layer A2 and the lithium foil as a counter electrode were opposed to each other via separators and contained in a container. Then, an electrolyte B2 was injected into this container, and the container was sealed to prepare a lithium-ion secondary battery C3. The lithium-ion secondary battery C3 was evaluated electrochemically in the same manner as the lithium-ion secondary battery C1. The average coulombic efficiency of the lithium-ion secondary battery C3 up to the 100 the cycle was 99.6%.

### Example 4

### Preparation of Negative Electrode Active Material Layer A3

A negative electrode mixture slurry was prepared by mixing silicon having a 33 m²/g specific surface area as a silicon-based negative electrode active material, a polyimide-based binder as a binder, a vapor deposition method carbon fiber (VGCF) as a conductive auxiliary agent, and carbon (KB) having a hollow-structure, and an appropriate amount of solvents. The obtained negative electrode mixture slurry was applied to a Cu foil as a negative electrode current collector, dried, and a negative electrode active material layer A3 was manufactured on the negative electrode current collector.

### Preparation of Lithium-Ion Secondary Battery C4 and Electrochemical Evaluation

The negative electrode active material layer A3 and the lithium foil as a counter electrode were opposed to each other via a separator and contained in a container. Then, an electrolyte B2 was injected into this container, and the container was sealed to prepare a lithium-ion secondary battery C4. The lithium-ion secondary battery C4 was evaluated electrochemically in the same manner as the lithium-ion secondary battery C1. The average coulombic efficiency of the lithium-ion secondary cell C4 up to the 100th cycle was 99.0%.

### Comparative Example 1

### Preparation of Lithium-Ion Secondary Battery c1 and Electrochemical Evaluation

A lithium foil as a negative electrode active material layer and a lithium foil as a counter electrode were opposed to each other via a separator and contained in a container. Then, an electrolyte B1 was injected into this container, and the container was sealed to prepare a lithium-ion secondary battery c1. The lithium-ion secondary battery c1 was evaluated electrochemically in the same manner as the lithium-ion secondary battery C1. The average coulombic efficiency of the lithium-ion secondary battery c1 up to the 100th cycle was 83.4%.

### Comparative Example 2

### Preparation of Electrolyte Solution b1

To a 1-ethyl3-methylimidazolium bis(fluorosulfonyl)imide (hereinafter, referred to as “EMIm-FSI”) as an ionic liquid, Li—FSI as a support salt containing lithium ions was dissolved so that the molar ratio (EMIm-FSI/Li—FSI) of EMIm-FSI to Li—FSI was 6, to preparate electrolyte solution b1.

### Preparation of Lithium-Ion Secondary Battery c2 and Electrochemical Evaluation

The negative electrode active material layer A1 and the lithium foil as a counter electrode were opposed to each other via a separator and contained in a container. Then, an electrolyte b1 was injected into this container, and the container was sealed to prepare a lithium-ion secondary battery c2. The lithium-ion secondary battery c2 was evaluated electrochemically in the same manner as the lithium-ion secondary battery C1. The average coulombic efficiency of the lithium-ion secondary battery c2 up to the 100th cycle was 96.8%.

### Comparative Example 3

### Preparation of Lithium-Ion Secondary Battery c3 and Electrical Evaluation

A lithium foil as a negative electrode active material layer and a lithium foil as a counter electrode were opposed to each other via a separator and contained in a container. Then, an electrolyte b1 was injected into this container, and the container was sealed to prepare a lithium-ion secondary battery c3. The lithium-ion secondary battery c3 was evaluated electrochemically in the same manner as the lithium-ion secondary battery C1. The average coulombic efficiency of the lithium-ion secondary battery c3 up to the 100th cycle was 97.2%.

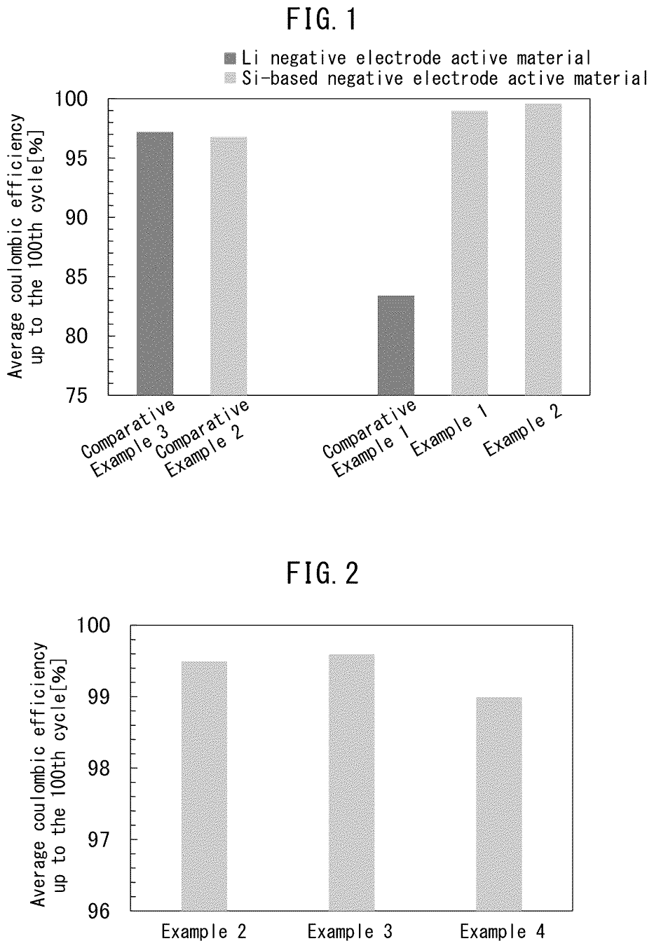

Table 1 shows the results of Examples 1 to 4 and Comparative Examples 1 to 3. FIG. 1 shows a graph comparing the average coulombic efficiencies of the lithium-ion secondary batteries in examples 1 and 2 and comparative examples 1 to 3. Also shown in FIG. 2 is a graph comparing the average Coulomb efficiency of the lithium-ion secondary batteries in Examples 2-3.

TABLE 1

| | | Example | Example | Example | Example | Comparative | Comparative | Comparative |
|---|---|---|---|---|---|---|---|---|
| | | 1 | 2 | 3 | 4 | example 1 | example 2 | example 3 |
| Negative electrode | | Negative | Negative | Negative | Negative | — | Negative | — |
| active material | | electrode | electrode | electrode | electrode | | electrode | |
| layer | | active | active | active | active | | active | |
| | | material | material | material | material | | material | |
| | | layer A1 | layer A1 | layer A2 | layer A3 | | layer A1 | |
| | Negative electrode | Silicon | Silicon | Silicon | Silicon | Lithium | Silicon | Lithium |
| | active material | | | | | | | |
| | Specific surface area | 1 | 1 | 25 | 33 | — | 1 | — |
| | of negative electrode | | | | | | | |
| | active material [m²/g] | | | | | | | |
| Electrolyte solution | | Electrolyte | Electrolyte | Electrolyte | Electrolyte | Electrolyte | Electrolyte | Electrolyte |
| | | solution B1 | solution B2 | solution B2 | solution B2 | solution B1 | solution b1 | solution b1 |
| | Ionic liquid | P2223-FS1 | P2223-FS1 | P2223-FS1 | P2223-FS1 | P2223-FS1 | EMIm-FSI | EMIm-FSI |
| | Lithium salt | Li-FSI | Li-FSI | Li-FSI | Li-FSI | Li-FSI | Li-FSI | Li-FSI |
| | Molar ratio of ionic | 6.0 | 1.5 | 1.5 | 1.5 | 6.0 | 6.0 | 6.0 |
| | liquid to lithium salt | | | | | | | |
| | [—] | | | | | | | |
| Lithium ion secondary | | Lithium ion | Lithium ion | Lithium ion | Lithium ion | Lithium ion | Lithium ion | Lithium ion |
| battery | | secondary | secondary | secondary | secondary | secondary | secondary | secondary |
| | | battery C1 | battery C2 | battery C3 | battery C4 | battery c1 | battery c2 | battery c3 |
| Evaluation | Average coulombic | 99.0 | 99.5 | 99.6 | 99.0 | 83.4 | 96.8 | 96.8 |
| | efficiency up to the | | | | | | | |
| | 100th cycle [%] | | | | | | | |

With respect to the silicon-based negative electrode active material, a lithium-ion secondary battery C1-C4 using an electrolyte solution that contains an ionic liquid P2223-LSI containing phosphonium ions could obtain a higher mean Coulombic Efficiency of 99.0% or more even after 100 the cycles (Examples 1 to 4). In particular, the lithium ion secondary cell C2, C3 in which the specific surface area of the silicon-based negative electrode active material is less than or equal to 25 m/g and the molar ratio of the ionic liquid to the lithium salt is less than or equal to 1.5 exhibited a high-average coulombic efficiency.

In the lithium-ion secondary battery C1-C4, it is presumed that the inclusion of phosphonium ions in the electrolytic solution forms a SEI that is effective in expanding and contracting the silicon-based negative electrode active material, that is, when the silicon-based negative electrode active material is used, SEI is cracked, and a new surface of SEI is formed, thereby suppressing the problem that SEI continues to grow, thereby improving the average Coulombic Efficiency. It is also inferred that the phosphonium ion is highly electrochemically stable, thereby suppressing SEI overformation, thereby improving the average Coulombic Efficiency.

On the other hand, it is presumed that the lithium-ion secondary battery c1 containing no silicon-based negative electrode active material has a low average coulombic efficiency of 83.4% after 100 cycles, and an electrolyte solution containing phosphonium ions is effective for the silicon-based negative electrode active material. In addition, the lithium-ion secondary cell c2 using the electrolyte including the ionic liquid EMIm-FSI not including the phosphonium ion also had a low mean coulombic efficiency of 96.8% after 100 cycles. this is presumed to indicate the usefulness of the phosphonium ion for the silicon-based negative electrode active material.

Embodiments of the lithium secondary battery of the present disclosure have thus been described, and those of ordinary skill in the art would understand that various modifications can be made without departing from the scope of Claims.

1. A lithium-ion secondary battery comprises, a negative electrode active material layer, a separator layer, and a positive electrode active material layer in the order mentioned,
wherein the negative electrode active material layer comprises a silicon-based negative electrode active material, and
wherein the negative electrode active material layer, the separator layer, and the positive electrode active material layer are impregnated with an electrolyte solution,
wherein the electrolyte solution comprises an ionic liquid and a lithium ion,
wherein the ionic liquid comprises a phosphonium ion and a bis(fluorosulfonyl)imide ion.

2. The lithium-ion secondary battery according to claim 1, wherein the phosphonium ion is a triethylpropylphosphonium ion.

3. The lithium-ion secondary battery according to claim 1, wherein the specific surface area of the silicon-based negative electrode active material is 25 m²/g or less.

4. The lithium-ion secondary battery according to claim 1, wherein the molar ratio of the total amount of moles of the phosphonium ion and the bis(fluorosulfonyl)imide ion to the total amount of moles of the lithium ion and the bis(fluorosulfonyl)imide ion is 1.5 or less.
